(19) United States
(12) Patent Application Publication
(10) Pub. No.: US 2016/0014467 A1
(43) Pub. Date: Jan. 14, 2016

(54) REMINDING METHOD AND SYSTEM OF PROGRAM BROADCASTING AND DISPLAY DEVICE

(71) Applicants: BOE TECHNOLOGY GROUP CO., LTD., Beijing (CN); BEIJING BOE MULTIMEDIA TECHNOLOGY CO., LTD., Beijing (CN)

(72) Inventor: Xiufeng ZHANG, Beijing (CN)

(73) Assignees: BOE TECHNOLOGY GROUP CO., LTD., Beijing (CN); Beijing BOE Multimedia Technology Co., Ltd., Beijing (CN)

(21) Appl. No.: 14/415,441

(22) PCT Filed: Apr. 25, 2014
(86) PCT No.: PCT/CN2014/076236

§ 371 Date: Jan. 16, 2015

(30) Foreign Application Priority Data
Dec. 26, 2013 (CN) 201310733926.7

(51) Int. Cl. H04N 21/488; H04N 21/442; H04N 21/45; H04N 21/4143; H04N 21/472; H04N 21/458; H04N 21/414; H04N 21/258; H04N 21/466

(52) U.S. Cl. CPC H04N 21/4882; H04N 21/25891; H04N 21/44204; H04N 21/4532; H04N 21/4667; H04N 21/47214; H04N 21/458; H04N 21/41407; H04N 21/4143

(57) ABSTRACT

The present invention provides a reminding method of program broadcasting and a reminding system of program broadcasting and a display device. The reminding method comprises: identifying a favorite program of a user; acquiring a broadcasting time of the favorite program; and sending reminding information of program broadcasting when an interval between the current time and the broadcasting time of the favorite program is less than or equal to a reminding time interval. According to the reminding method, the user may be prevented from missing the broadcasting of the favorite program, broadcasting channels no longer need to be sequentially searched after the user receives the reminding information, and aimless waiting for the program is no longer needed, so that the time and effort of the user are saved, and great convenience is provided for the user to timely and accurately watch the favorite program.

### FIELD OF THE INVENTION

The present invention relates to the field of display technology, and in particular relates to a reminding method of program broadcasting, a reminding system of program broadcasting and a display device.

### BACKGROUND OF THE INVENTION

Nowadays, types of television programs are increasingly diverse, channels are numerous, and oriented audiences are different. Different user groups watch personal favorite program types.

In the process of implementing the present invention, the inventor discovers that at least the following technical problem exists in the prior art: most users watch relatively fixed program types and are always difficult in memorizing all channels and broadcasting time of favorite programs due to present numerous programs and channels, so that the users may not timely watch the favorite programs because they forget the broadcasting channels or miss the broadcasting time.

With the increase of program types, when users watch television, if they ceaselessly switch channels to look for their favorite programs, time is always wasted; and the watched interested programs need to be searched again or waited during next watching because the broadcasting channels or time is forgotten, so that the time and effort of the users are also wasted.

### SUMMARY OF THE INVENTION

In view of the above technical problems existing in the prior art, the present invention provides a reminding method of program broadcasting, a reminding system of program broadcasting and a display device adopting the method or system. By adopting the reminding method and system, a user may be prevented from missing the broadcasting of a favorite program, broadcasting channels no longer need to be sequentially searched after the user receives reminding information, and aimless waiting for the program is no longer needed, so that the time and effort of the user are saved, and great convenience is provided for the user to timely and accurately watch the favorite program.

The present invention provides a reminding method of program broadcasting, including the following steps:

identifying a favorite program of a user;

acquiring a broadcasting time of the favorite program; and

sending reminding information of program broadcasting when an interval between the current time and the broadcasting time of the favorite program is less than or equal to a reminding time interval.

Preferably, the step of identifying the favorite program of the user includes:

presetting an identification time length and/or identification frequency;

recording a time length and/or frequency for watching a program by the user, judging whether the recorded time length and/or frequency for watching the program are/is more than or equal to the identification time length and/or identification frequency, and determining whether the watched program is the favorite program based on the judging result; and

storing information of the favorite program when the favorite program is determined,

wherein the information of the favorite program includes a program name and a broadcasting channel.

Preferably, the step of sending the reminding information of program broadcasting when the interval between the current time and the broadcasting time of the favorite program is less than or equal to the reminding time interval includes:

presetting the reminding time interval;

comparing the acquired broadcasting time of the favorite program with the current time to obtain an actual time interval;

judging whether the actual time interval is less than or equal to the reminding time interval; and

determining whether the reminding information of program broadcasting is sent based on the judging result,

wherein the reminding information of program broadcasting is sent in a character, image or sound form, and includes the information of the favorite program and the acquired broadcasting time of the favorite program.

Further preferably, the step of sending the reminding information of program broadcasting includes: sending the reminding information of program broadcasting once within the reminding time interval; or sending the reminding information of program broadcasting once every sub time period, wherein length of the sub time period is less than the reminding time interval.

Further preferably, the reminding method further includes the following steps:

receiving feedback information on the reminding information of program broadcasting from the user; and

determining whether to play the favorite program according to content of the feedback information,

wherein the feedback information is in a character, image or sound form, and the content of the feedback information includes an acknowledgement of playing a program or an acknowledgement of not playing a program.

The present invention further provides a reminding system of program broadcasting, including an identification module, an acquisition module, a comparison module and a communication module;

the identification module is configured to identify whether a broadcasted program is a favorite program of a user and send an identification signal to the comparison module;

the acquisition module is configured to acquire the broadcasting time of the favorite program and send the broadcasting time of the favorite program to the comparison module;

the comparison module is configured to compare the broadcasting time of the favorite program with the current time according to the identification signal and send a comparing result signal to the communication module when an interval between the current time and the broadcasting time of the favorite program is less than or equal to a reminding time interval; and

the communication module is configured to send reminding information of program broadcasting according to the comparing result signal.

Preferably, the identification module includes a first presetting module, a judgment module and a storage module;

the first presetting module is configured to preset an identification time length and/or identification frequency;

the judgment module is configured to record a time length and/or frequency for watching a program by the user and judge whether the recorded time length and/or frequency for watching the program are/is more than or equal to the identification time length and/or identification frequency; and

the storage module is configured to store information of the favorite program according to judging result of the judgment module,

wherein the information of the favorite program includes a program name and a broadcasting channel.

Preferably, information of a plurality of favorite programs of multiple users may be stored in the storage module.

Preferably, the comparison module includes a second presetting module, which is configured to preset the reminding time interval.

Further preferably, the reminding system further includes a user terminal, wherein the user terminal includes a receiving module which is configured to receive the reminding information of program broadcasting sent by the communication module in a character, image or sound form, and the reminding information of program broadcasting includes the information of the favorite program and the acquired broadcasting time of the favorite program.

Preferably, the user terminal further includes a sending module which is configured to send feedback information of the user to the communication module with respect to the reminding information of program broadcasting, wherein the feedback information is in a character, image or sound form, and content of the feedback information includes an acknowledgement of playing a program or an acknowledgement of not playing a program.

Preferably, the user terminal includes a mobile phone, a pager or a computer.

Further preferably, the communication module is further configured to receive the feedback information sent by the user terminal and send the feedback information to the comparison module;

the comparison module is further configured to send a playing command to a program playing unit according to the content of the feedback information,

wherein the content of the feedback information includes an acknowledgement of playing a program or an acknowledgement of not playing a program.

The present invention further provides a display device, including the above reminding system of program broadcasting.

Preferably, in a case where the reminding system of program broadcasting of the display device includes the above sending module, the display device further includes a program playing unit which is configured to control the display device according to the content of the feedback information to switch channel to broadcasting channel of the favorite program, and play the favorite program when it is the broadcasting time of the favorite program.

The present invention has the beneficial effects: according to the reminding method of program broadcasting provided by the present invention, the favorite program of the user is identified first, then the broadcasting time of the favorite program is acquired, and the reminding information is sent to the user within the reminding time interval before the favorite program is broadcasted, so as to remind the user to timely and accurately watch the favorite program; and according to the reminding system of program broadcasting provided by the present invention, the identification module identifies the favorite program of the user, the comparison module compares the broadcasting time of the favorite program with the current time and sends the comparing result signal to the communication module when the interval between the current time and the broadcasting time of the favorite program is less than or equal to the reminding time interval, and the communication module finally sends the reminding information of program broadcasting to the user according to the comparing result signal, so as to remind the user to timely and accurately watch the favorite program. By adopting the reminding method of program broadcasting and the reminding system of program broadcasting, the user may be prevented from missing the broadcasting of the favorite program, broadcasting channels no longer need to be sequentially searched after the user receives the reminding information, and aimless waiting for the program is no longer needed, so that the time and effort of the user are saved, and great convenience is provided for the user to timely and accurately watch the favorite program. Since the display device provided by the present invention adopts the above reminding system of program broadcasting, great convenience is provided for the user to timely and accurately watch the favorite television program.

### BRIEF DESCRIPTION OF THE DRAWINGS

FIG. 1 is a flow diagram of a reminding method of program broadcasting in embodiment 1 of the present invention;

FIG. 2 is a sub flow diagram of a step of identifying a favorite program of a user in FIG. 1;

FIG. 3 is a sub flow diagram of a step of sending reminding information of program broadcasting in FIG. 1;

FIG. 4 is a flow diagram of a reminding method of program broadcasting in embodiment 2 of the present invention;

FIG. 5 is a structural block diagram of a reminding system of program broadcasting in embodiment 3 of the present invention;

FIG. 6 is a structural block diagram of a reminding system of program broadcasting in embodiment 4 of the present invention.

### REFERENCE NUMERALS

1, identification module; 11, first presetting module; 12, judgment module; 13, storage module; 2, comparison module; 21, second presetting module; 3, communication module; 4, user terminal; 41, receiving module; 42, sending module; 5, acquisition module.

### DETAILED DESCRIPTION OF THE EMBODIMENTS

To make those skilled in the art better understand the technical solutions of the present invention, a reminding method of program broadcasting, a reminding system of program broadcasting and a display device adopting the reminding method or system of program broadcasting provided by the present invention will be further described in detail below in combination with the accompanying drawings and specific embodiments.

### Embodiment 1

This embodiment provides a reminding method of program broadcasting, as shown in FIG. 1 to FIG. 3, including steps of 101 to 103.

Step 101: identifying a favorite program of a user.

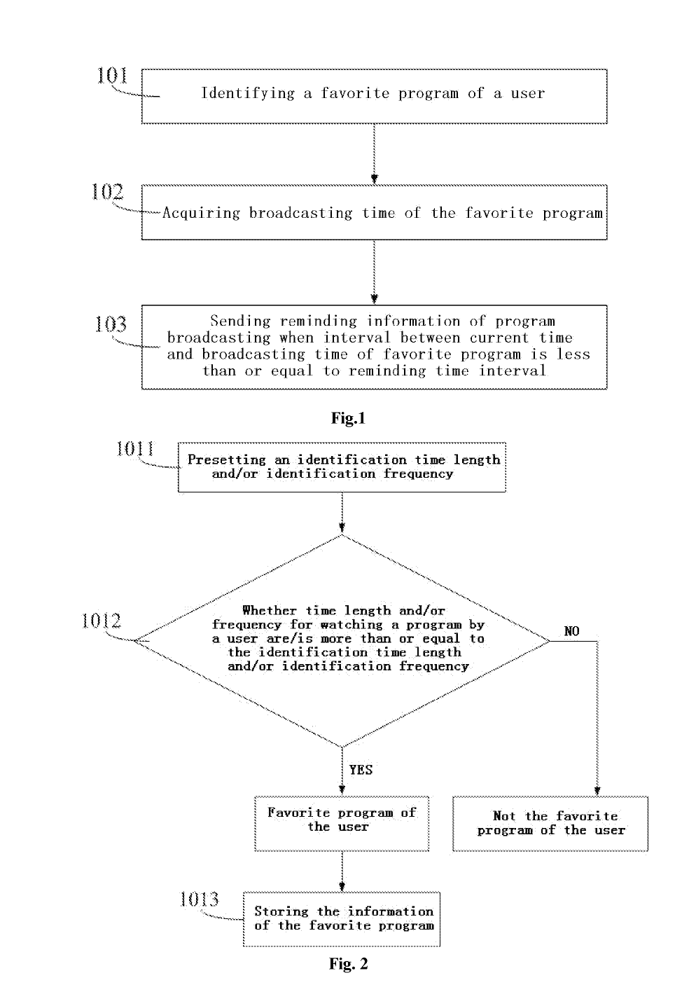

As shown in FIG. 2, this step further includes:

Step 1011: presetting an identification time length and/or identification frequency.

Step 1012: recording a time length and/or frequency for watching a program by the user, judging whether the recorded time length and/or frequency for watching the program are/is more than or equal to the identification time length and/or identification frequency, and determining whether the watched program is the favorite program based on the judging result.

In this step, when the time length and/or frequency for watching the program are/is more than or equal to the identification time length and/or identification frequency (“YES” in step 1012), it is determined that the watched program is the favorite program; otherwise, when the time length and/or frequency for watching the program are/is less than the identification time length and/or identification frequency (“NO” in step 1012), it is determined that the watched program is not the favorite program. Wherein, any of the time length and frequency for watching the program by the user may be used as judgment criteria of the favorite program, or, both the time length and frequency for watching the program by the user may be used as the judgment criteria of the favorite program. As such a configuration, the favorite program of the user can be flexibly and relatively accurately identified.

Step 1013: storing the information of the favorite program when the favorite program is determined in step 1012.

In this step, the information of the favorite program includes a program name and a broadcasting channel. Wherein, the storage of the program name and the broadcasting channel is favorable for the user to make a feedback or determine the channel according to the program name and the broadcasting channel in the information of the favorite program when the reminding information of program broadcasting including the information of the favorite program is sent to the user later, so that broadcasting channels no longer need to be sequentially searched.

With reference to FIG. 1 again, step 102 of the reminding method of program broadcasting of this embodiment is described. In the step 102, the broadcasting time of the favorite program is acquired.

For example, the broadcasting time of the favorite program identified in step 101 may be acquired in advance according to an electronic program guide (EPG), and the electronic program guide is generally given in advance and is also fixed, so that the reminding information is more accurate.

Step 103: when the interval between the current time and the broadcasting time of the favorite program is less than or equal to a reminding time interval, sending reminding information of program broadcasting.

Wherein, the reminding time interval indicates a time period to the broadcasting time of the program before the program is broadcasted, and the user may be reminded before the program is broadcasted within the time period. The reminding time interval may be a preset default or set by the user according to personal habit, e.g. half an hour before the broadcasting time of a program is set as the reminding time interval.

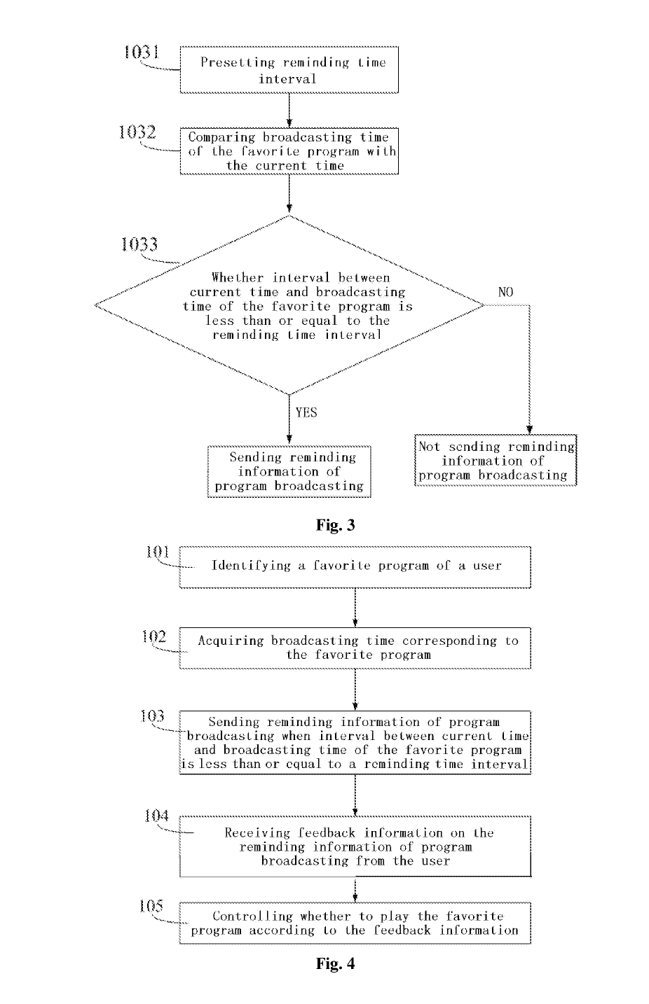

As shown in FIG. 3, step 103 further includes:

step 1031: presetting the reminding time interval;

step 1032: comparing the broadcasting time of the favorite program with the current time to obtain an actual time interval; and

step 1033: judging whether the actual time interval is less than or equal to the reminding time interval. When the judging result is “YES”, the reminding information of program broadcasting is sent; and when the judging result is “NO”, the reminding information of program broadcasting is not sent.

In this step, the reminding information of program broadcasting may be sent in a character, image or sound form, and includes the above-mentioned stored information of the favorite program and the acquired broadcasting time of the favorite program.

In addition, in this step, the reminding information of program broadcasting is sent once within the reminding time interval before the program is broadcasted, e.g. when the interval between the current time and the broadcasting time of the favorite program is equal to 1 hour, the reminding information of program broadcasting is sent once; preferably, the reminding information of program broadcasting is sent once every sub time period within the reminding time interval before the program is broadcasted, wherein the length of the sub time period is less than the reminding time interval, e.g. the reminding information is sent once every half an hour or 15 minutes within the reminding time interval of 1 hour. Thus, the user may be reminded for multiple times before the favorite program is broadcasted, and the user may be prevented from missing watching.

### Embodiment 2

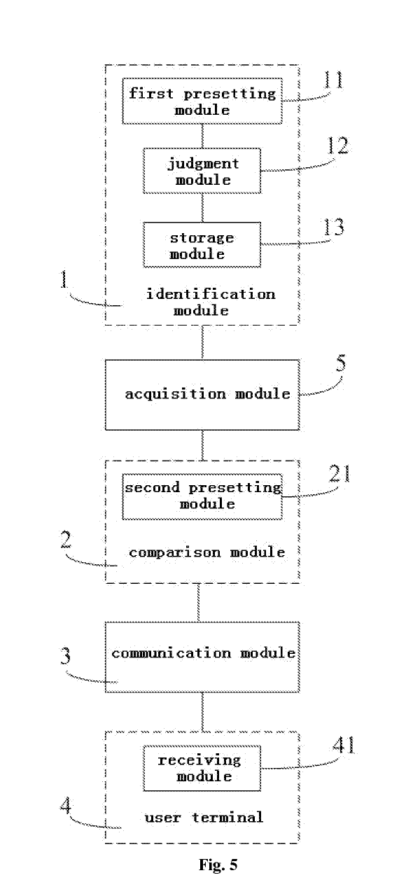

This embodiment provides a reminding method of program broadcasting. Different from embodiment 1, as shown in FIG. 4, based on the reminding method provided in embodiment 1, the reminding method in this embodiment further includes:

step 104: receiving feedback information on the reminding information of program broadcasting from the user; and

step 105: determining whether to play the favorite program according to content of the feedback information.

In these steps, the feedback information is in a character, image or sound form. The content of the feedback information includes an acknowledgement of playing a program or an acknowledgement of not playing a program.

In step 104 and step 105, with respect to the reminding information of program broadcasting, the user send the feedback information to a program playing unit in a television, which is used for providing user control of playing a program, and the content of the feedback information is an acknowledgement of playing a program or an acknowledgement of not playing a program. If the playing of the program is acknowledged, after the feedback information is received, the program playing unit may directly switch channel to a channel corresponding to the broadcasting channel indicated in the information of the favorite program when the television is in a state of power-on, and play the favorite program of the user when it is the broadcasting time of the favorite program; or the program playing unit may automatically boot the television in a standby state, switch channel to a channel corresponding to the broadcasting channel indicated in the information of the favorite program, and play the favorite program of the user when it is the broadcasting time of the favorite program. If not playing the program is acknowledged, after the program playing unit receives the feedback information, the program playing unit does not directly switch channel to a channel corresponding to the broadcasting channel indicated in the information of the favorite program in the state of power-on, and does not play the favorite program of the user when it is the broadcasting time of the favorite program; or the program playing unit may not automatically boot a television in a standby state or switch channel to a channel corresponding to the broadcasting channel indicated in the information of the favorite program, and does not play the favorite program of the user when it is the broadcasting time of the favorite program. If the user does not send the feedback information, the program playing unit does not perform further operation.

With such configurations, it is favorable for forming an interaction between the user and the program playing unit, and more convenience is provided for the user to timely and accurately watch the favorite program.

Embodiments 1 and 2 have the beneficial effects: according to the reminding method of program broadcasting provided by embodiments 1 and 2, the favorite program of the user is identified, the information of the favorite program is stored, the broadcasting time of the favorite program is acquired, and then the reminding information of program broadcasting is sent to the user within the reminding time interval before the favorite program is broadcasted, so as to remind the user to timely and accurately watch the favorite program. The user may be prevented from missing the broadcasting of the favorite program, broadcasting channels no longer need to be sequentially searched after the user receives the reminding information, and aimless waiting for the program is also no longer needed. Therefore, the time and effort of the user are saved, and then great convenience is provided for the user to timely and accurately watch the favorite program.

### Embodiment 3

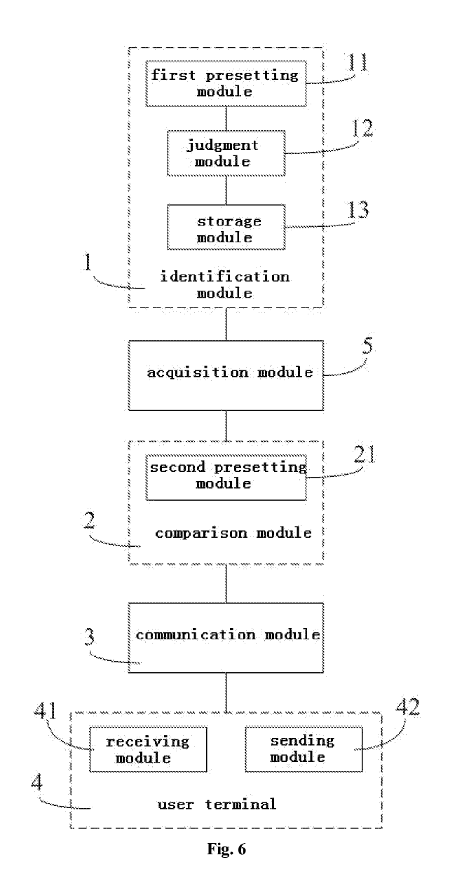

This embodiment provides a reminding system of program broadcasting, which may realize the reminding method of program broadcasting in embodiment 1. As shown in FIG. 5, the reminding system includes an identification module 1, an acquisition module 5, a comparison module 2 and a communication module 3.

The identification module 1 is configured to identify whether a broadcasted program is a favorite program of a user and send an identification signal indicating an identification result to the comparison module 2, so that the comparison module 2 performs the following comparison according to the identification signal. The acquisition module 5 is configured to acquire the broadcasting time of the favorite program and send the broadcasting time of the favorite program to the comparison module 2. The comparison module 2 is configured to compare the broadcasting time of the favorite program with the current time according to the identification signal and send a comparing result signal to the communication module 3 when the interval between the current time and the broadcasting time of the favorite program is less than or equal to a reminding time interval. The communication module 3 is configured to send reminding information of program broadcasting according to the comparing result signal. Wherein, as mentioned in embodiment 1, the reminding information of program broadcasting may be sent for one time or multiple times, and the sending time or sending interval of the reminding information of program broadcasting may be set freely.

In this embodiment, the identification module 1 further includes a first presetting module 11, a judgment module 12 and a storage module 13.

The first presetting module 11 is configured to preset an identification time length and/or identification frequency.

The judgment module 12 is configured to record a time length and/or frequency for watching a program by the user and judge whether the recorded time length and/or frequency for watching the program are/is more than or equal to the identification time length and/or identification frequency.

The storage module 13 is configured to store the information of the favorite program according to the judging result of the judgment module 12. Wherein, as mentioned in embodiment 1, the information of the favorite program includes a program name and a broadcasting channel. That is, if the time length and/or frequency of the watched program are/is more than or equal to the identification time length and/or identification frequency, it is determined that the program is the favorite program of the user, so that the storage module stores the program name and the broadcasting channel of the program.

Preferably, the storage module 13 may store the information of a plurality of favorite programs of multiple users, e.g. the information of 3 to 4 favorite programs of 3 to 4 users. Thus, great convenience is provided for the multiple users to timely and accurately watch personal favorite programs.

In this embodiment, the comparison module 2 further includes a second presetting module 21, which is configured to preset the reminding time interval.

It should be noted that, the reminding time interval may also be preset by the first presetting module 11, namely the second presetting module 21 may not be provided in the comparison module 2. Or, the first presetting module 11 and the second presetting module 21 are modules which are independent from the identification module 1 or the comparison module 2 and have setting and storing functions, and information is transmitted between the modules and the identification module 1 or the comparison module 2 respectively.

In addition, in this embodiment, the reminding system further includes a user terminal 4, wherein the user terminal 4 includes a receiving module 41 which is configured to receive the reminding information of program broadcasting sent by the communication module 3 in a character, image or sound form. As mentioned in embodiment 1, the reminding information of program broadcasting includes the information of the favorite program stored by the storage module 13 and the broadcasting time of the favorite program acquired by the acquisition module 5. Preferably, the user terminal 4 includes a mobile phone, a pager or a computer; e.g. the mobile phone receives a text message, the pager receives a call, or the computer receives an E-mail and the like, these user terminals 4 may timely and conveniently receive the reminding information of program broadcasting sent by the communication module 3, so that the user may conveniently and timely receive the reminding information.

### Embodiment 4

This embodiment provides a reminding system of program broadcasting. Different from embodiment 3, as shown in FIG. 6, on the basis of the reminding system in embodiment 3, the user terminal 4 in this embodiment further includes a sending module 42 which is configured to send the feedback information of the user to the communication module 3, with respect to the received reminding information of program broadcasting. Wherein, the feedback information is in a character, image or sound form, and the content of the feedback information includes an acknowledgement of playing a program or an acknowledgement of not playing a program.

In addition, based on the reminding system in embodiment 3, the communication module 3 is further configured to receive the feedback information sent by the user terminal 4 and send the feedback information to the comparison module 2.

Meanwhile, the comparison module 2 is further configured to send a playing command to a program playing unit for controlling the playing of programs in a display device such as a television according to the content of the feedback information. The program playing unit may directly switch channel to a channel corresponding to the broadcasting channel indicated in the information of the favorite program when the display device is in a state of power on according to the received playing command, and play the favorite program of the user when it is the broadcasting time of the favorite program; or the program playing unit may automatically boot the display device in a standby state, switch channel to a channel corresponding to the broadcasting channel indicated in the information of the favorite program, and play the favorite program when it is the broadcasting time of the favorite program.

With such configurations, it is favorable for forming an interaction between the user and the program playing unit, and more convenience is provided for the user to timely and accurately watch the favorite program.

Embodiment 3 and embodiment 4 have the beneficial effects: according to the reminding system of program broadcasting provided by embodiment 3 and embodiment 4, the identification module identifies the favorite program of the user, the storage module stores the information of the favorite program, the acquisition program acquires the broadcasting time of the favorite program, and then the communication module sends the reminding information of program broadcasting to the user within the reminding time interval before the favorite program is broadcasted, so as to remind the user to timely and accurately watch the favorite program. The user may be prevented from missing the broadcasting of the favorite program, broadcasting channels no longer need to be sequentially searched after the user receives the reminding information, and aimless waiting for the program is also no longer needed, so that the time and effort of the user are saved, and great convenience is provided for the user to timely and accurately watch the favorite program.

### Embodiment 5

This embodiment provides a display device, including either of the reminding systems of program broadcasting in embodiments 3 and 4.

The reminding system of program broadcasting is integrated inside or outside the display device, or, part of modules of the reminding system of program broadcasting may be formed by directly using the modules with the same functions in the display device, e.g. the storage module in the reminding system of program broadcasting may directly adopt a storage unit for storing video data in the display device, of course, other modules may also be handled similarly.

Preferably, in a case where the reminding system of the display device includes the sending module for sending the feedback information of the user, the display device may further include a program playing unit which is configured to receive a playing command from the reminding system, switch channel to the broadcasting channel of the favorite program according to the received playing command and play the favorite program when it is the broadcasting time of the favorite program.

The display device adopts either of the reminding systems in embodiments 3 and 4, so that great convenience is provided for the user to timely and accurately watch the favorite television program.

It could be easily understood that, for a broadcast lover, the reminding system of program broadcasting may also be applied to a broadcast playing device, so that a user may timely and accurately listen to a favorite broadcast program.

It could be understood that, the above embodiments are merely exemplary embodiments adopted for describing the principle of the present invention, rather than limiting the present invention. Various variations and improvements may be made for those of ordinary skill in the art without departing from the spirit and essence of the present invention, and these variations and improvements are regarded within the protection scope of the present invention.

1-15. (canceled)

16. A reminding method of program broadcasting, comprising the following steps:
identifying a favorite program of a user;
acquiring a broadcasting time of the favorite program; and
sending reminding information of program broadcasting when an interval between the current time and the broadcasting time of the favorite program is less than or equal to a reminding time interval.

17. The reminding method of claim 16, wherein the step of identifying the favorite program of the user comprises:
presetting an identification time length and/or identification frequency;
recording a time length and/or frequency for watching a program by the user, judging whether the recorded time length and/or frequency for watching the program are/is more than or equal to the identification time length and/or identification frequency, and determining whether the watched program is the favorite program according to the judging result; and
storing information of the favorite program when the favorite program is determined,
wherein the information of the favorite program comprises a program name and a broadcasting channel.

18. The reminding method of claim 17, wherein the step of sending the reminding information of program broadcasting when the interval between the current time and the broadcasting time of the favorite program is less than or equal to the reminding time interval comprises:
presetting the reminding time interval;
comparing the broadcasting time of the favorite program with the current time to obtain an actual time interval;
judging whether the actual time interval is less than or equal to the reminding time interval; and
determining whether the reminding information of program broadcasting is sent according to the judging result,
wherein the reminding information of program broadcasting is sent in a character, image or sound form, and comprises the information of the favorite program and the broadcasting time of the favorite program.

19. The reminding method of claim 18, wherein the step of sending the reminding information of program broadcasting comprises: sending the reminding information of program broadcasting once within the reminding time interval; or sending the reminding information of program broadcasting once every sub time period, wherein length of the sub time period is less than the reminding time interval.

20. The reminding method of claim 16, further comprising the following steps:
receiving feedback information on the reminding information of program broadcasting from the user; and
determining whether to play the favorite program according to content of the feedback information,
wherein the feedback information is in a character, image or sound form, and the content of the feedback information comprises an acknowledgement of playing a program or an acknowledgement of not playing a program.

21. The reminding method of claim 17, further comprising the following steps:
receiving feedback information on the reminding information of program broadcasting from the user; and
determining whether to play the favorite program according to content of the feedback information,
wherein the feedback information is in a character, image or sound form, and the content of the feedback information comprises an acknowledgement of playing a program or an acknowledgement of not playing a program.

22. The reminding method of claim 18, further comprising the following steps:
receiving feedback information on the reminding information of program broadcasting from the user; and
determining whether to play the favorite program according to content of the feedback information,
wherein the feedback information is in a character, image or sound form, and the content of the feedback information comprises an acknowledgement of playing a program or an acknowledgement of not playing a program.

23. The reminding method of claim 19, further comprising the following steps:
receiving feedback information on the reminding information of program broadcasting from the user; and
determining whether to play the favorite program according to content of the feedback information,
wherein the feedback information is in a character, image or sound form, and the content of the feedback information comprises an acknowledgement of playing a program or an acknowledgement of not playing a program.

24. A reminding system of program broadcasting, comprising an identification module, an acquisition module, a comparison module and a communication module;
the identification module is configured to identify whether a broadcasted program is a favorite program of a user and send an identification signal indicating an identification result to the comparison module;
the acquisition module is configured to acquire broadcasting time of the favorite program and send the broadcasting time of the favorite program to the comparison module;
the comparison module is configured to compare the broadcasting time of the favorite program with current time according to the identification signal and send a comparing result signal to the communication module when an interval between the current time and the broadcasting time of the favorite program is less than or equal to a reminding time interval; and
the communication module is configured to send reminding information of program broadcasting according to the comparing result signal.

25. The reminding system of claim 24, wherein the identification module comprises a first presetting module, a judgment module and a storage module;
the first presetting module is configured to preset an identification time length and/or identification frequency;
the judgment module is configured to record a time length and/or frequency for watching a program by the user and judge whether the recorded time length and/or frequency for watching the program are/is more than or equal to the identification time length and/or identification frequency; and
the storage module is configured to store information of the favorite program according to judging result of the judgment module,
wherein the information of the favorite program comprises a program name and a broadcasting channel.

26. The reminding system of claim 25, wherein the storage module stores information of a plurality of favorite programs of multiple users.

27. The reminding system of claim 24, wherein the comparison module comprises a second presetting module, which is configured to preset the reminding time interval.

28. The reminding system of claim 25, further comprising a user terminal, wherein the user terminal comprises a receiving module which is configured to receive the reminding information of program broadcasting sent by the communication module in a character, image or sound form, and the reminding information of program broadcasting comprises the information of the favorite program and the broadcasting time of the favorite program.

29. The reminding system of claim 28, wherein the user terminal further comprises a sending module which is configured to send feedback information of the user to the communication module with respect to the reminding information of program broadcasting, wherein the feedback information is in a character, image or sound form, and content of the feedback information comprises an acknowledgement of playing a program or an acknowledgement of not playing a program.

30. The reminding system of claim 29, wherein the communication module is further configured to receive the feedback information sent by the user terminal and send the feedback information to the comparison module;
the comparison module is further configured to send a playing command to a program playing unit according to the content of the feedback information,
wherein the content of the feedback information comprises an acknowledgement of playing a program or an acknowledgement of not playing a program.

31. The reminding system of claim 28, wherein the user terminal comprises a mobile phone, a pager or a computer.

32. The reminding system of claim 29, wherein the user terminal comprises a mobile phone, a pager or a computer.

33. The reminding system of claim 30, wherein the user terminal comprises a mobile phone, a pager or a computer.

34. A display device, comprising the reminding system of claim 24.

35. The display device of claim 34, wherein in a case where the identification module of the reminding system comprises a first presetting module, a judgment module and a storage module;
the first presetting module is configured to preset an identification time length and/or identification frequency;
the judgment module is configured to record a time length and/or frequency for watching a program by the user and judge whether the recorded time length and/or frequency for watching the program are/is more than or equal to the identification time length and/or identification frequency; and
the storage module is configured to store information of the favorite program according to judging result of the judgment module,
wherein the information of the favorite program comprises a program name and a broadcasting channel;
wherein the storage module stores information of a plurality of favorite programs of multiple users;
and wherein the display device further comprises a program playing unit which is configured to control the display device according to the content of the feedback information to switch channel to broadcasting channel of the favorite program, and play the favorite program when it is the broadcasting time of the favorite program.
